(19) United States
(12) Patent Application Publication
(10) Pub. No.: US 2009/0271483 A1
(43) Pub. Date: Oct. 29, 2009

(54) METHOD FOR REPUBLICATION OF PUBLISHED MESSAGES AS APPENDS ON A SEPARATE RETAINED TOPIC

(75) Inventors: Matthew Robert Whitehead, Winchester (GB); Laura Cowen, Southampton (GB); Benjamin Joseph Fletcher, Huddersfield (GB)

Correspondence Address: IBM CORPORATION (SWP), C/O SUITER SWANTZ PC LLO, 14301 FNB PARKWAY, SUITE 220, OMAHA, NE, 68154-5299, US

(73) Assignee: INTERNATIONAL BUSINESS MACHINES CORPORATION, Armonk, NY (US)

(21) Appl. No.: 12/108,969

(22) Filed: Apr. 24, 2008

(51) Int. Cl. G06F 15/16

(52) U.S. Cl. 709/206

(57) ABSTRACT

A method for republication of published messages includes receiving a published message on a topic from a publisher, storing the published message as an appended retained message, republishing the appended retained message on a history topic, receiving a request from a subscriber to view at least a portion of the appended retained message, and transmitting the republished message to a subscriber subscribing to the topic after the published message has been published via the history topic.

### TECHNICAL FIELD

The present invention relates to the field of data processing and more specifically to data processing which distributes messages from suppliers (called, hereinafter, “publishers”) of data messages to consumers (called, hereinafter “subscribers”) of such messages.

### BACKGROUND

In existing publish/subscribe messaging models, there are two ways a message on a topic may be published. The message may be published as “event” information i.e. as a non-retained message, or as “state” information i.e. as a retained message. Generally, when a message published on a given topic has been received by all subscribers on that topic, the message is lost (although the message engine might choose to log information about the message, it is not available to any subsequent or existing subscribers). When a message is published as a retained message on a given topic, any previous retained message on that topic is lost. Again, this might be logged by the message engine but it is no longer available to subscribers.

### SUMMARY

The present application discloses a method for republication of published messages including, but not limited to: receiving a published message on a topic from a publisher; storing the published message as an appended retained message; republishing the appended retained message on a history topic; receiving a request from a subscriber to view at least a portion of the appended retained message; and transmitting the republished message to a subscriber subscribing to the topic after the published message has been published via the history topic.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram of a method for republication of published messages.

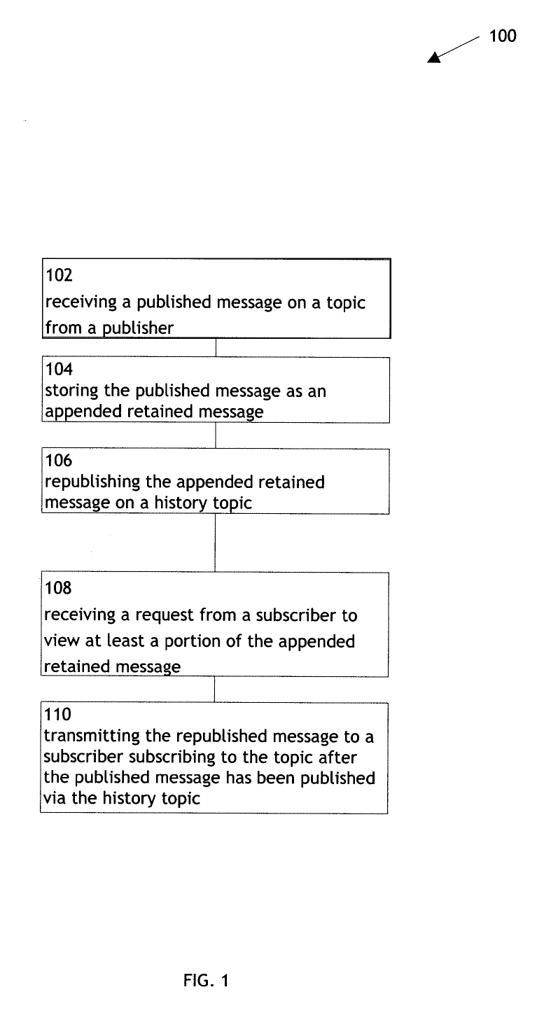

### DETAILED DESCRIPTION

Reference will now be made in detail to the subject matter disclosed, which is illustrated in the accompanying drawings.

One or more publishers may connect to a publish/subscribe network and send published messages to a network which distributes the messages to subscribers. Publishers, which may be data processing applications configured to output data messages, connect to network using an inter-application data connection protocol known as remote procedure call (or RPC). Each publisher application may run on a separate machine, alternatively, a single machine may run a plurality of publisher applications. A typical use of a publish/subscribe topic may include a publisher publishing information about any faults arising on server1 to a topic such as:
topic/machines/server1/faults

The publisher may connect to a publish/subscribe distribution agent process, which is included in a group of such processes making up a broker network, and send messages to the distribution agent process, specifying the subject of the message to the distribution agent process. The distribution agent process then distributes the published messages to subscriber applications which have previously indicated to the publish/subscribe network that they would like to receive data messages on particular subjects. Thus, the subscribers also do not need to know the identity or location of the publishers. The subscribers need only connect to a distribution agent process.

A subscriber subscribed to “topic/machines/server1/faults” may receive all or substantially all messages published on the topic as and when a message is published. If a subscriber subscribes to “topic/machines/server1/faults” after a given message has been published, and the message is a non-retained message, the subscriber does not receive the message. A subscriber may be unable to determine which messages were published prior to subscription to the topic. If the topic includes one or more retained messages, the subscriber may receive only the last retained message (all previous retained messages are overwritten).

The examples given (e.g., “/machines/server1/faults” and “history/machines/server1/faults” topics) are representative of many different possible implementations. In an additional embodiment, an additional API parameter may be utilized to indicate that only the history message is required.

Method 100 may provide a message published at any time on a given topic (either as a retained or a non-retained message) available on a separate topic as a single, retained, message history.

Method 100 may include receiving a published message from a publisher 102. For instance, publisher may publish information a fault arising on server1 to “topic/machines/server1/faults.”

Method 100 may include republishing the message onto a history topic as a retained, appended message 104. Republishing of the message may occur without the knowledge of either publisher or subscriber.

Method 100 may include transmitting the republished message to a subscriber via the history topic 106. Continuing the example above, a subscriber to the history topic may receive a single message containing the history of all (or some, depending on implementation) messages published. Continuing the example above, a subscriber may subscribe to “topic/history/machines/server1/faults” and receive a complete history of messages published on the “topic/history/machines/server1/faults”. In some instances, method may transmit a portion of the history of messages. For example, a method may provide date parameters (e.g., transmit history for topic up to 1 year) selectable by the subscriber.

Method 100 may be implemented with any publish/subscribe messaging system. Publish/subscribe messaging system may include at least one publisher and at least one subscriber. Publish/subscribe messaging system may also include an intermediary broker. The intermediary broker may perform a store-and-forward function to route messages from publishers to subscribers. A subscriber may register a subscription with the intermediary broker. Intermediary broker may also perform filtering, or selecting messages for reception and processing for subscriber.

The publish/subscribe messaging system may distribute routing and filtering functions among the publishers and subscribers. Publish/subscribe messaging system may also map publish/subscribe topics to IP multicast groups, allowing data transfer from the publisher to a subscriber with a single message. Subscriber may perform content-based filtering before a message is passed up to the application layer. Using the a communication network (e.g., the) Internet, a World Wide Web browser application (the term “application” or “process” refers to a software program, or portion thereof, running on a computer) may be utilized in conjunction with the publisher or subscriber in order to graphically display messages.

Publish/subscribe messaging system may be topic-based, where messages are published to “topics” or named logical channels. Subscribers receive all messages published to a subscribed topic and all subscribers to a topic will receive a substantially identical message. The publisher defines the classes of messages to which subscribers can subscribe. Publish/subscribe messaging system may be content-based, where a message is delivered to a subscriber if an attribute or the content of the message matches one or more constraints defined by the subscriber. In a content based system, the subscriber may be responsible for classifying the messages. Additionally, publish/subscribe messaging system may be a hybrid topic-based/content-based messaging system, where publishers post messages to a topic while subscribers register content-based subscriptions to one or more topics.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for republishing published messages comprising:
receiving a published message on a topic from a publisher;
storing the published message as an appended retained message;
republishing the appended retained message on a history topic;
receiving a request from a subscriber to view at least a portion of the appended retained message; and
transmitting the republished message to a subscriber subscribing to the topic after the published message has been published via the history topic.
